(19) United States
(12) Patent Application Publication
(10) Pub. No.: US 2026/0045597 A1
(43) Pub. Date: Feb. 12, 2026

(54) BATTERY AND PRODUCTION METHOD FOR BATTERY

(71) Applicant: TOYOTA JIDOSHA KABUSHIKI KAISHA, Toyota-shi (JP)

(72) Inventors: Kenichi KAKISHITA, Nagoya-shi (JP); Ryo KAGAMI, Ichinomiya-shi (JP)

(73) Assignee: TOYOTA JIDOSHA KABUSHIKI KAISHA, Toyota-shi (JP)

(21) Appl. No.: 19/078,690

(22) Filed: Mar. 13, 2025

(30) Foreign Application Priority Data
Aug. 9, 2024 (JP) 2024-134647

(51) Int. Cl. H01M 50/103; H01M 10/0585; H01M 10/653; H01M 50/15

(52) U.S. Cl. CPC H01M 50/103; H01M 10/0585; H01M 10/653; H01M 50/15

(57) ABSTRACT

A battery includes: an electrode stack that has a rectangular plate shape and in which a positive electrode current collector, a positive electrode active material, a solid electrolyte, a negative electrode active material, and a negative electrode current collector are stacked; and a battery case in which the electrode stack is housed. The battery case includes a case body that is a chassis having a tubular shape and that includes opening portions having a rectangular shape, the opening portions being provided on two facing surfaces of the case body, and terminal wall portions that seal the opening portions, and the electrode stack includes a chamfered portion where at least some of a plurality of corner portions provided at an end portion of the electrode stack in a facing direction of the opening portions is chamfered.

### CROSS-REFERENCE TO RELATED APPLICATION

This application claims priority to Japanese Patent Application No. 2024-134647 filed on Aug. 9, 2024. The disclosure of the above-identified application, including the specification, drawings, and claims, is incorporated by reference herein in its entirety.

### BACKGROUND

### 1. Technical Field

The present disclosure relates to a battery and a production method for a battery.

### 2. Description of Related Art

WO 2021/230009 discloses a battery in which a chamfered portion is provided at a corner portion of an electrode stack (battery element) and in which the chamfered portion is covered with an insulating member.

### SUMMARY

It is known that the expansion-contraction amount at the time of charge and discharge is smaller in a solid-state battery in which an electrolyte layer of an electrode stack contains a solid electrolyte, compared to a battery in which a liquid electrolyte is used. Therefore, it is preferable that the gap between a battery case and the electrode stack is as small as possible in a state where the electrode stack is housed. However, in that case, there is a problem in that it is not easy to restrain the interference between the battery case and the electrode stack in a step of inserting the electrode stack into the battery case.

In this regard, when the corner portion of the electrode stack is chamfered as in the case of the battery described in WO 2021/230009, it is expected that the above interference is restrained. However, in the technology in WO 2021/230009, the whole of a side of electrode stack formed in a rectangular parallelepiped shape is chamfered as the corner portion. Accordingly, the energy density of the battery decreases.

In view of the above circumstance, the present disclosure has an object to provide a battery and a production method for a battery that make it possible to improve the insertability of the electrode stack into the battery case and to increase the energy density.

A battery according to a first aspect of the present disclosure is a battery including: an electrode stack that has a rectangular plate shape and in which a positive electrode current collector, a positive electrode active material, a solid electrolyte, a negative electrode active material, and a negative electrode current collector are stacked; and a battery case in which the electrode stack is housed. The battery case includes a case body that is a chassis having a tubular shape and that includes opening portions having a rectangular shape, the opening portions being provided on two facing surfaces of the case body, and lid bodies that seal the opening portions, and the electrode stack includes a chamfered portion where at least some of a plurality of corner portions provided at an end portion of the electrode stack in a facing direction of the opening portions is chamfered.

In the battery according to the first aspect, the battery includes the electrode stack that has a rectangular plate shape and in which the positive electrode current collector, the positive electrode active material, the solid electrolyte, the negative electrode active material, and the negative electrode current collector are stacked, and is a so-called solid-state battery. The battery case in which the electrode stack is housed includes the case body that is a chassis and the lid bodies, and the lid bodies seal the opening portions having a rectangular shape and provided on the two facing surfaces of the case body. Accordingly, the electrode stack having a rectangular plate shape passes through the rectangular opening portion of the case body, and is housed in the interior of the battery case.

The electrode stack includes the chamfered portion where at least some of the corner portions provided at the end portion in the facing direction of the opening portions is chamfered. Therefore, when the electrode stack is put into the battery case, it is possible to restrain the interference between the opening portion of the case body and the corner portions of the electrode stack, and to improve the insertability of the electrode stack into the battery case.

Furthermore, at the chamfered portion, the corner portion provided at the end portion of the electrode stack and corresponding to the position of the opening portion of the case body is chamfered, and therefore, the volume that is removed is smaller compared to a case where the whole of a side of the electrode stack is chamfered as a corner portion. Thereby, it is possible to increase the energy density of the battery.

In a battery according to a second aspect of the present disclosure, in the configuration described in the first aspect, at the chamfered portion, a chamfered surface may be a flat surface having a triangular shape.

In the battery according to the second aspect, the chamfered surface at the chamfered portion is configured as a flat surface having a triangular shape, and therefore, the chamfered portion can be formed by cutting the corner portion of the electrode stack along a predetermined planar direction. Therefore, it is possible to easily perform the processing and reduce the production cost, compared to a configuration in which the chamfered surface is a curved surface having an R-shape, for example.

In a battery according to a third aspect of the present disclosure, in the configuration described the first aspect or the second aspect, a heat conductive member may be disposed between the end portion where the chamfered portion is provided and an inner surface of the battery case, in the interior of the battery case.

In the battery according to the third aspect, the heat conductive member is disposed between the end portion of the electrode stack where the chamfered portion is provided and the inner surface of the battery case. Therefore, it is possible to restrain an air space from being provided between the chamfered portion and the inner surface of the battery case, and to increase the heat release performance of the battery.

In the battery according to a fourth aspect of the present disclosure, in the configuration described in the third aspect, the number of the positive electrode current collectors may be more than the number of the negative electrode current collectors, in the electrode stack, and the chamfered portion may be provided at a corner portion of the end portion on a negative electrode side, in the electrode stack.

In the battery according to the fourth aspect, the number of the positive electrode current collectors is more than the number of the negative electrode current collectors, in the electrode stack, and therefore, it is harder for the negative electrode current collector to release the heat generated by energization, compared to the positive electrode current collector. Therefore, the chamfered portion is provided at the corner portion of the end portion on the negative electrode side in the electrode stack, and thereby, the heat release performance at the vicinity of the negative electrode current collector is enhanced because the heat conductive member is sufficiently disposed. Thereby, it is possible to increase the heat release performance at a portion in the battery where the temperature easily increases at the time of heat generation.

In the battery according to a fifth aspect of the present disclosure, in the configuration described in the fourth aspect, the chamfered portion may not be provided at the corner portion of the end portion on a positive electrode side, in the electrode stack.

In the battery according to the fifth aspect, at the corner portion of the end portion of the electrode stack on the negative electrode side, the chamfered portion is provided, and the heat conductive member is sufficiently disposed. On the other hand, at the corner portion of the end portion on the positive electrode side, the chamfered portion is not provided. Thereby, it is possible to efficiently increase the heat release performance at the portion in the battery where the temperature easily increases at the time of heat generation, and to minimize the volume that is removed by chamfering. It is possible to efficiently increase the energy density of the battery.

A production method for a battery according to a sixth aspect of the present disclosure is a production method for the battery described in the first aspect, and includes: chamfering the at least some of the corner portions provided at the end portion of the electrode stack in the facing direction of the opening portions; and inserting the electrode stack into the interior of the case body, so as to insert the end portion where the at least some of the corner portions is chamfered, into one of the opening portions of the case body.

In the production method for the battery according to the sixth aspect, at least some of the corner portions provided at the end portion of the electrode stack in the facing direction of the opening portions is chamfered, and the electrode stack is inserted into the interior of the case body. In the step of the insertion, the end portion of the electrode stack where the corner portion is chamfered is inserted into the opening portion of the case body, and thereby, it is possible to restrain the interference between the opening portion of the case body and the corner portion of the electrode stack, and to improve the insertability of the electrode stack into the battery case. Furthermore, with the method, it is possible to obtain a battery having a high energy density.

As described above, with the battery and the production method for the battery according to the present disclosure, it is possible to improve the insertability of the electrode stack into the battery case, and to increase the energy density.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery according to an embodiment;

FIG. 2 is a sectional view of a battery case that schematically shows a state where the battery case is cut along line 2-2 in FIG. 1;

FIG. 3 is a sectional view of the battery case that schematically shows a state where the battery case is cut along line 3-3 in FIG. 2;

FIG. 4 is a sectional view of an electrode stack that schematically shows a state where the electrode stack is cut along line 4-4 in FIG. 2;

FIG. 5 is a perspective view that schematically shows an end portion of the electrode stack according to the embodiment and chamfered portions provided at the end portion;

FIG. 6A is a schematic view for describing a production method for the battery according to the embodiment, and shows a step of chamfering corner portions of the electrode stack;

FIG. 6B is a schematic view for describing the production method for the battery according to the embodiment, and shows a step of inserting the electrode stack into a case body of the battery case;

FIG. 6C is a schematic view for describing the production method for the battery according to the embodiment, and shows a step of joining the electrode stack and internal terminals; and

FIG. 6D is a schematic view for describing the production method for the battery according to the embodiment, and shows a step of joining the case body of the battery case and terminal wall portions.

### DETAILED DESCRIPTION OF EMBODIMENTS

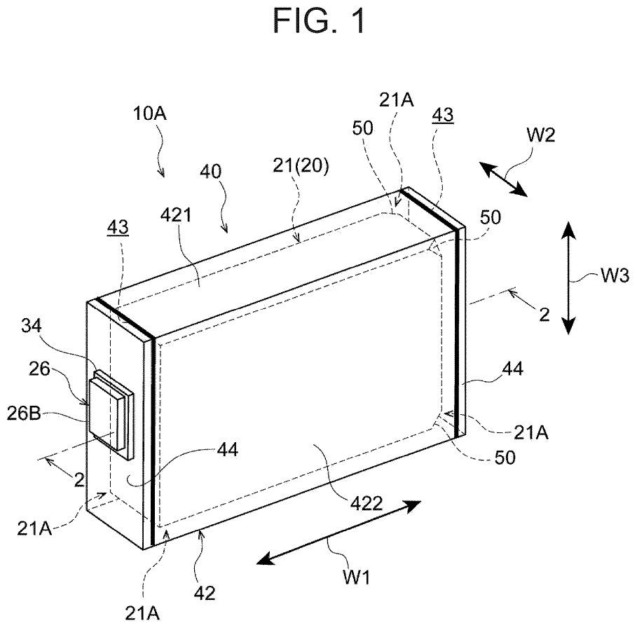

A battery 10A according to an embodiment will be described below based on FIG. 1 to FIG. 6D. An arrow W1, an arrow W2, and an arrow W3 that are shown in the figures when necessary indicate a first direction, a second direction, and a third direction, respectively. The first direction, the second direction, and the third direction are directions that are orthogonal to each other. Further, in the embodiment, the first direction W1 coincides with the width direction of the battery 10A. The second direction W2 coincides with the thickness direction of the battery 10A. The third direction W3 coincides with the height direction of the battery 10A.

Unless otherwise mentioned in the specification, as for each kind of element, the number of elements is not limited to one, and a plurality of elements may exist. Further, in the drawings, substantially identical elements are denoted by identical reference characters, and in the specification, repetitive descriptions are omitted.

Further, in the present specification, the term “step” includes a step that is independent from other steps, and in addition, includes a step that makes it possible to achieve the purpose of the step although the step cannot be clearly distinguished from other steps.

### Battery

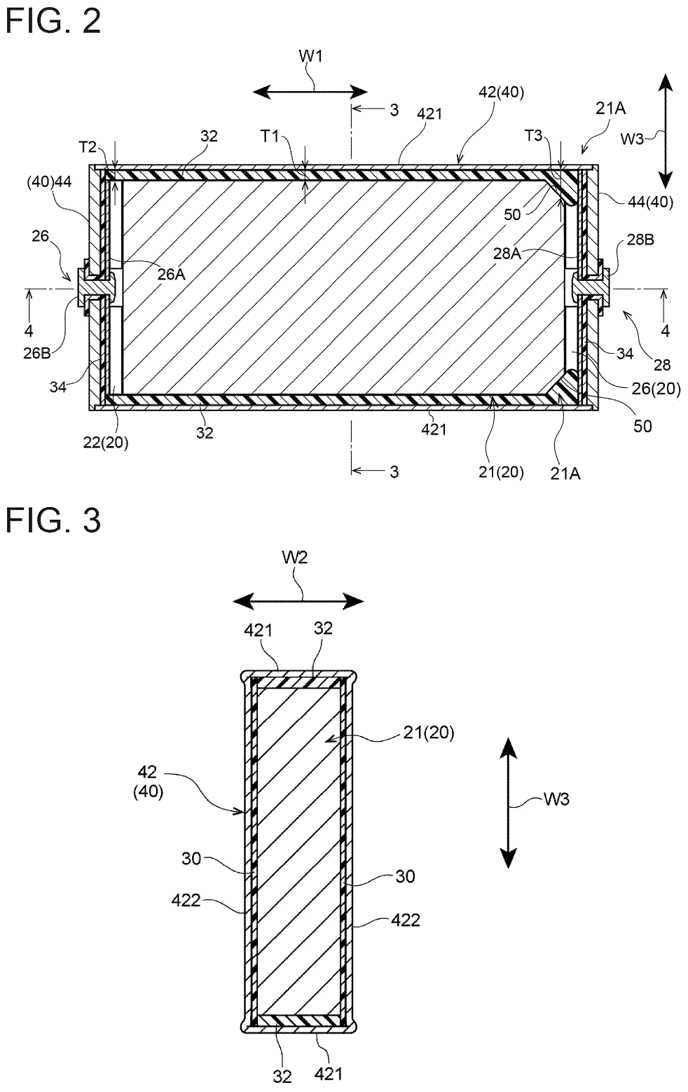

FIG. 1 is a perspective view of the battery 10A according to the embodiment. FIG. 2 is a sectional view of a battery case 40 that schematically shows a state where the battery case 40 is cut along line 2-2 in FIG. 1. FIG. 3 is a sectional view of the battery case 40 that schematically shows a state where the battery case 40 is cut along line 3-3 in FIG. 2. As shown in FIG. 1 to FIG. 3, the battery 10A is configured to include an electrode stack 20 that includes a positive electrode and a negative electrode, and the battery case 40 that houses the electrode stack 20.

### Battery Case

The battery case 40 is configured to include a case body 42 that is a chassis having a tubular shape, and terminal wall portions 44 that are lid bodies. The terminal wall portions 44 seal two openings of the case body 42. For example, the case body 42 and a pair of terminal wall portions 44 are formed of a metal plate composed of aluminum, iron, or the like.

The case body 42 includes a pair of short-side sidewall portions 421 facing each other in the third direction W3, and a pair of long-side sidewall portions 422 facing each other in the second direction W2, and opening portions 43 having a rectangular shape are formed by the short-side sidewall portions 421 and the long-side sidewall portions 422. In the case body 42, the opening portions 43 having a rectangular shape constitute two surfaces facing each other in the first direction W1.

The short-side sidewall portions 421 constitute an upper surface and bottom surface of the battery case 40, and extend such that the first direction W1 is adopted as a longer direction and the second direction W2 is adopted as a shorter direction. Therefore, two sides of the short sides of each opening portion 43 of the case body 42 are constituted.

The long-side sidewall portions 422 constitute both side surfaces (a front surface and a back surface) of the battery case 40 in the thickness direction of the battery case 40, and extend such that the first direction W1 is adopted as a longer direction and the third direction W3 is adopted as a shorter direction. Therefore, two sides of the long sides of each opening portion 43 of the case body 42 are constituted.

For example, the case body 42 may be formed by the extrusion molding of an aluminum material or the like. Alternatively, the chassis having a tubular shape may be formed by bending one flat plate by bending work using a press machine and by welding end portions of the flat plate.

In the embodiment, inner surfaces of the short-side sidewall portions 421 and long-side sidewall portions 422 that face the electrode stack 20 are constituted by flat surfaces.

On the terminal wall portions 44, a positive electrode terminal 26 and a negative electrode terminal 28 are respectively disposed as electrode terminals. The terminal wall portions 44 are formed in a rectangular plate shape in which the first direction W1 is adopted as a plate thickness direction, and include through-holes (reference characters are omitted) into which a later-described positive electrode-side external terminal 26B and negative electrode-side external terminal 28B are inserted.

The positive electrode terminal 26 includes a positive electrode-side internal terminal 26A that is disposed in the interior of the battery case 40, and the positive electrode-side external terminal 26B that is disposed in the exterior of the battery case 40. The positive electrode-side internal terminal 26A is formed in a rectangular plate shape in which the first direction W1 is adopted as a plate thickness direction, and is disposed along an inner side surface of the terminal wall portion 44. To the positive electrode-side internal terminal 26A, positive electrode current collecting tabs 22 of the electrode stack 20 are electrically connected. Further, the positive electrode-side internal terminal 26A includes a through-hole (reference character is omitted) into which the positive electrode-side external terminal 26B is inserted.

The positive electrode-side external terminal 26B is constituted by a metallic rivet, for example. The positive electrode-side external terminal 26B is inserted into the through-holes of the terminal wall portion 44 and the positive electrode-side internal terminal 26A, and is fixed such that an end portion of the positive electrode-side external terminal 26B in the axial direction is deformed. That is, the positive electrode-side external terminal 26B is fixed to the terminal wall portion 44 and the positive electrode-side internal terminal 26A, by riveting.

Further, an insulating member 34 is interposed between the terminal wall portion 44 of the battery case 40 and the positive electrode terminal 26, and electrically insulates the battery case 40 and the positive electrode terminal 26 from each other.

The negative electrode terminal 28 includes a negative electrode-side internal terminal 28A that is disposed in the interior of the battery case 40, and the negative electrode-side external terminal 28B that is disposed in the exterior of the battery case 40. To the negative electrode-side internal terminal 28A, negative electrode current collecting tabs 23 of the electrode stack 20 are electrically connected. The configuration of the negative electrode terminal 28 is the same as the configuration of the positive electrode terminal 26, and therefore, detailed descriptions thereof are omitted.

### Electrode Stack

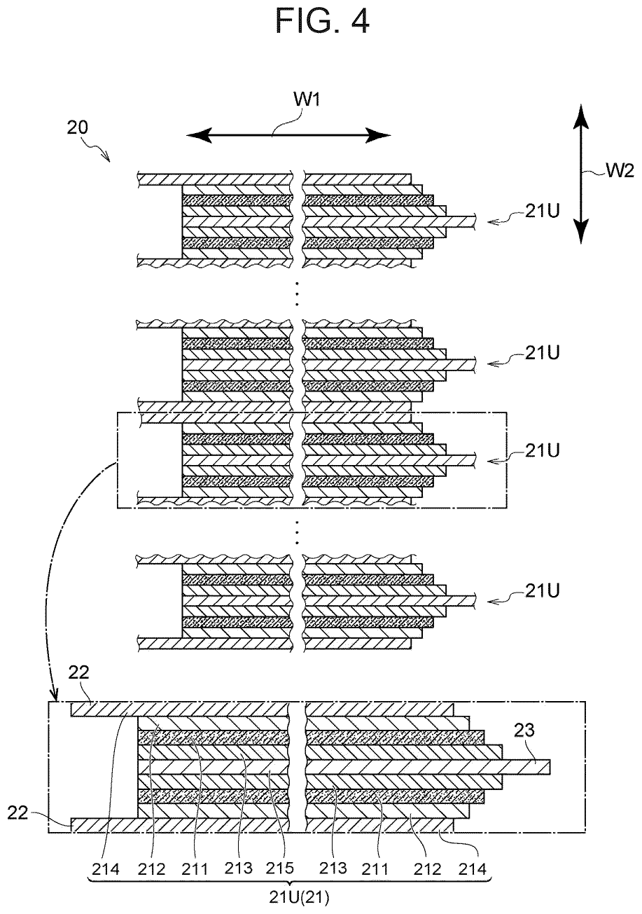

FIG. 4 is a sectional view of the electrode stack 20 that schematically shows a state where the electrode stack 20 is cut along line 4-4 in FIG. 2. As shown in FIG. 2 and FIG. 4, the electrode stack 20 is formed in a rectangular plate shape, as a whole. The electrode stack 20 includes an electrode body 21, a plurality of positive electrode current collecting tabs 22, and a plurality of negative electrode current collecting tabs 23. The electrode body 21 includes a plurality of unit electrode bodies 21U. The unit electrode bodies 21U are stacked along the second direction W2. The unit electrode bodies 21U are electrically connected in parallel.

As an example, the electrode body 21 is formed in a rectangular parallelepiped shape (rectangular plate shape) in which the first direction W1 is adopted as a width direction and the second direction W2 is adopted as a thickness direction. The positive electrode current collecting tabs 22 are provided so as to protrude from one side of the electrode body 21 in the first direction W1. The negative electrode current collecting tabs 23 are provided so as to protrude from the other side of the electrode body 21 in the first direction W1.

The stacked structure of the unit electrode body 21U is a monopolar-type structure. Specifically, the unit electrode body 21U includes two solid electrolyte layers 211, two positive electrode active material layers 212, two negative electrode active material layers 213, two positive electrode current collectors 214, and one negative electrode current collector 215. The positive electrode current collector 214, the positive electrode active material layer 212, the solid electrolyte layer 211, the negative electrode active material layer 213, the negative electrode current collector 215, the negative electrode active material layer 213, the solid electrolyte layer 211, the positive electrode active material layer 212, and the positive electrode current collector 214 are stacked along the second direction W2 in this order.

One positive electrode current collecting tab 22 is connected to one positive electrode current collector 214. One negative electrode current collecting tab 23 is connected to one negative electrode current collector 215. The number of the positive electrode current collecting tabs 22 of the electrode stack 20 is more than the number of the negative electrode current collecting tabs 23 of the electrode stack 20.

The solid electrolyte layer 211 contains a solid electrolyte. The solid electrolyte is not particularly limited, and may contain an aggregate of a plurality of particles. It is preferable that the solid electrolyte contains one selected from the group consisting of a sulfide solid electrolyte, an oxide solid electrolyte, and a halide solid electrolyte. The solid electrolyte may be a known solid electrolyte.

The solid electrolyte layer may further contain a binder. The binder may be used for the binding among solid electrolytes. The binder may be used for the binding between the solid electrolyte and the positive electrode active material layer 112 or the negative electrode active material layer 113. Examples of the binder include vinyl halide resins (for example, polyvinylidene fluoride (PVdF)), rubbers (for example, an acrylate-butadiene rubber (ABR) or a styrene-butadiene rubber (SBR)), and polyolefin resins (for example, polyethylene (PE) or polypropylene (PP)).

The positive electrode active material layer 212 contains a positive electrode active material. The positive electrode active material layer 212 may contain at least one of a positive electrode solid electrolyte, a conduction aid, and a binder, as necessary.

It is preferable that a lithium composite oxide may be contained as the positive electrode active material. The lithium composite oxide may contain at least one kind selected from the group consisting of F, Cl, N, S, Br, and I. Further, the lithium composite oxide may have a crystal structure that belongs to at least one space group selected from space groups R-3m, Immm, and P63-mmc. Further, in the lithium composite oxide, a main array of a transition metal, oxygen, and lithium may form an O2-type structure. The positive electrode active material may be a known positive electrode active material.

Examples of the positive electrode solid electrolyte are the same as the examples described as the solid electrolyte that is contained in the solid electrolyte layer.

Examples of the conduction aid include carbon materials (for example, carbon black, carbon nanotube, plumbago, or carbon fluoride), metal materials (for example, aluminum powder or conductive whisker), and conductive polymer materials (for example, polyaniline, polypyrrole, or polythiophene).

Examples of the binder are the same as the examples described as the binder that is contained in the solid electrolyte layer.

The negative electrode active material layer 213 contains a negative electrode active material. The negative electrode active material layer 213 may contain at least one of a negative electrode solid electrolyte, a conduction aid, and a binder, as necessary.

Examples of the negative electrode active material include Li active materials (for example, metal lithium), carbon active materials (for example, graphite), oxide active materials (for example, lithium titanate), and Si active materials (for example, elemental Si).

Examples of the negative electrode solid electrolyte are the same as the examples described as the positive electrode solid electrolyte that can be used in the positive electrode active material layer.

Examples of the conduction aid that can be used in the negative electrode active material layer are the same as the examples described as the conduction aid that can be used in the positive electrode active material layer.

Examples of the binder that can be used in the negative electrode active material layer are the same as the examples described as the binder that can be used in the positive electrode active material layer.

The positive electrode current collector 214 performs current collection for the positive electrode active material layer 212. The material of the positive electrode current collector is not particularly limited, and for example, there are stainless steel, aluminum, copper, nickel, iron, titanium, and carbon. The positive electrode current collector may be an aluminum alloy foil or an aluminum foil. The aluminum alloy foil and the aluminum foil may be produced using powders. Examples of the form of the positive electrode current collector include a foil form and a mesh form. The positive electrode current collector may be configured such that a buffer layer, an elastic layer, or a positive temperature coefficient (PTC) thermistor layer is disposed on a surface of the positive electrode current collector.

The negative electrode current collector 215 performs current collection for the negative electrode active material layer 213. The material of the negative electrode current collector is not particularly limited, and for example, there are stainless steel, aluminum, copper, nickel, iron, titanium, and carbon. The negative electrode current collector may be a copper foil. Examples of the form of the negative electrode current collector include a foil form or a mesh form. The negative electrode current collector may be configured such that a buffer layer, an elastic layer, or a positive temperature coefficient (PTC) thermistor layer is disposed on a surface of the negative electrode current collector.

The positive electrode current collecting tabs 22 electrically connect the positive electrode current collector 214 and the positive electrode terminal 26. The positive electrode current collecting tabs 22 are connected to the positive electrode current collector 214. The positive electrode current collecting tabs 22 protrude toward one side of the width direction (first direction W1) of the electrode body 21. Specifically, a bundle including the positive electrode current collecting tabs 22 is electrically connected to the positive electrode terminal 26. It is preferable that the positive electrode current collecting tabs 22 are formed so as to be continuous with the positive electrode current collector 214. The material of the positive electrode current collecting tabs is not particularly limited, and may be a metal (for example, aluminum, stainless (SUS), or nickel).

The negative electrode current collecting tabs 23 electrically connect the negative electrode current collector 215 and the negative electrode terminal 28. The negative electrode current collecting tabs 23 are connected to the negative electrode current collector 215. The negative electrode current collecting tabs 23 protrude toward the other side of the width direction (first direction W1) of the electrode body 21. Specifically, a bundle including the negative electrode current collecting tabs 23 is electrically connected to the negative electrode terminal 28. It is preferable that the negative electrode current collecting tabs 23 are formed so as to be continuous with the positive electrode current collector 214. The material of the negative electrode current collecting tabs is not particularly limited, and may be a metal (for example, aluminum, stainless (SUS), or nickel).

The electrode stack 20 having the above configuration is disposed in the interior of the battery case 40, in a state where a pair of resin sheets 30 as insulating members is disposed on both side surfaces in the second direction W2 (see FIG. 3).

The material of the resin sheet includes a known resin (a thermoplastic resin, a thermosetting resin, or the like). The thermoplastic resin may be an elastomer.

The resin sheet may further contain a heat conductive filler as necessary. The material of the heat conductive filler is not particularly limited, and there are metal oxides (for example, alumina, silica, or magnesia), metal nitrides (for example, aluminum nitride, silicon nitride, or boron nitride), artificial diamond, silicon carbide, and others.

The resin sheet may further contain a blending agent as necessary. Examples of the blending agent include a glass fiber, a carbon fiber, a filling material such as inorganic powder, a heat stabilizer, an antioxidant, a pigment, a weather-resisting agent, a fire retardant, a plasticizer, a dispersant, a lubricant, a mold-releasing agent, and an antistatic agent.

Further, in the electrode stack 20 having the above configuration, a pair of resin filling bodies 32 as heat conductive members is disposed on both side surfaces in the third direction W3 (see FIG. 2 and FIG. 3).

Examples of the material of the resin filling body 32 are the same as the examples described as the material of the resin sheet 30. The material of the resin filling body may be the same as the material of the resin sheet, or may be different from the material of the resin sheet.

There is a tendency that heat conductivity enhances and electric insulation decreases as the content of the heat conductive filler is higher. The heat conductivity of the resin filling body 32 may be higher than that of the resin sheet 30, and the electric insulation of the resin filling body 32 may be lower than that of the resin sheet 30.

In the embodiment, the resin filling body 32 is composed of a resin containing a heat conductive filler, and has a high heat conductivity. As an example, the heat conductivity of the resin filling body 32 is set so as to be higher than that of an air space.

The resin sheets 30 and the resin filling bodies 32 are disposed between the battery case 40 and the electrode stack 20, in a state where the electrode stack 20 is housed in the interior of the battery case 40. The battery case 40 and the electrode stack 20 are electrically insulated by the resin sheets 30 and the resin filling bodies 32.

### Chamfered Portion

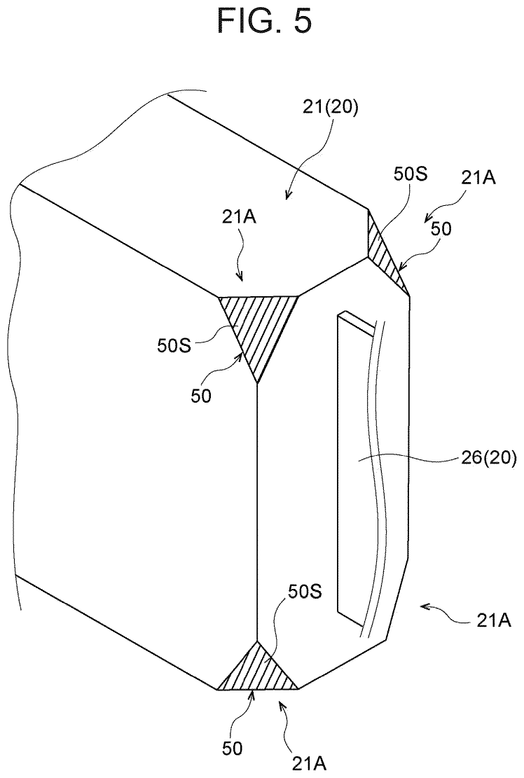

A chamfered portion 50 that is a principal part of the present disclosure will be described. FIG. 5 is a perspective view of the other end portion of the electrode stack 20, and schematically shows chamfered portions 50 where corner portions 21A provided at the end portion are chamfered.

The chamfered portion 50 is formed at an end portion of the electrode stack 20 in the first direction W1. More specifically, at an end portion of the rectangular parallelepiped electrode body 21 in the first direction W1, the chamfered portions 50 are provided at at least some corner portions 21A of the corner portions 21A provided at the end portion. Note that, the first direction W1 coincides with the facing direction of the two opening portions 43 of the case body 42.

In the embodiment, as an example, in the electrode body 21, the chamfered portions 50 are formed at the other end portion in the first direction W1, that is, at the end portion on the negative electrode side on which the negative electrode current collector 215 is disposed. Further, in the electrode body 21, the chamfered portion 50 is not provided at the corner portion 21A of the end portion (that is, the one end portion in the first direction W1) on the positive electrode side (see FIG. 1 and FIG. 2).

Note that, the configuration in which the chamfered portion 50 is not provided at the end portion on the positive electrode side is not essential. The chamfered portion 50 may be provided at the one end portion of the electrode body 21 in the first direction W1, that is, the end portion on the positive electrode side on which the positive electrode current collectors 214 are disposed.

As shown in FIG. 5, four corner portions 21A are provided at the end portion of the electrode body 21 on the negative electrode side. The number of the chamfered portions 50 is not particularly limited, and the chamfered portion 50 may be provided at some of the four corner portions 21A, or may be provided at all of the four corner portions 21A. In the embodiment, all corner portions 21A are chamfered, and chamfered portions 50 are provided at four spots.

As an example, the chamfered portion 50 is formed by cutting the corner portion 21A of the electrode body 21 along a predetermined planar direction. Therefore, at the chamfered portion 50, a chamfered surface 50S is a flat surface having a triangular shape.

Note that, the shape of the chamfered surface 50S is not particularly limited, and for example, a curved surface having an R-shape may be adopted.

As shown in FIG. 2, in a state where the electrode stack 20 having the above configuration is housed in the battery case 40, a resin filling body (heat conductive member) is disposed between the end portion (corner portions 21A) of the electrode body 21 where the chamfered portions 50 are provided and the inner surface of the battery case 40, in the interior of the battery case 40. For example, the resin filling body 32 is provided over the whole of the interval between the end portion (corner portions 21A) of the electrode body 21 and the inner surface of the battery case 40, and contacts with the chamfered surfaces 50S of the electrode body 21 and the inner surface of the battery case 40. Therefore, as for the thickness of the resin filling body 32 in the third direction W3, a thickness T3 of the other end portion in the first direction W1 is larger than a thickness T1 of a central portion in the first direction W1. Further, the thickness T3 of the other end portion in the first direction W1 is larger than a thickness T2 of the one end portion in the first direction W1. Therefore, in the interior of the battery case 40, the heat release effect due to the resin filling body 32 is increased at the other end portion in the first direction.

Furthermore, at the other end portion in the first direction W1 within the battery case 40, the surface area of the electrode body 21 is increased by the chamfered portions 50, and therefore, the contact area between the resin filling body 32 and the electrode body 21 is increased compared to corner portions 21A that are not provided with other chamfered portions 50. This point also enhances the heat release effect due to the resin filling body 32.

### Production Method for Battery

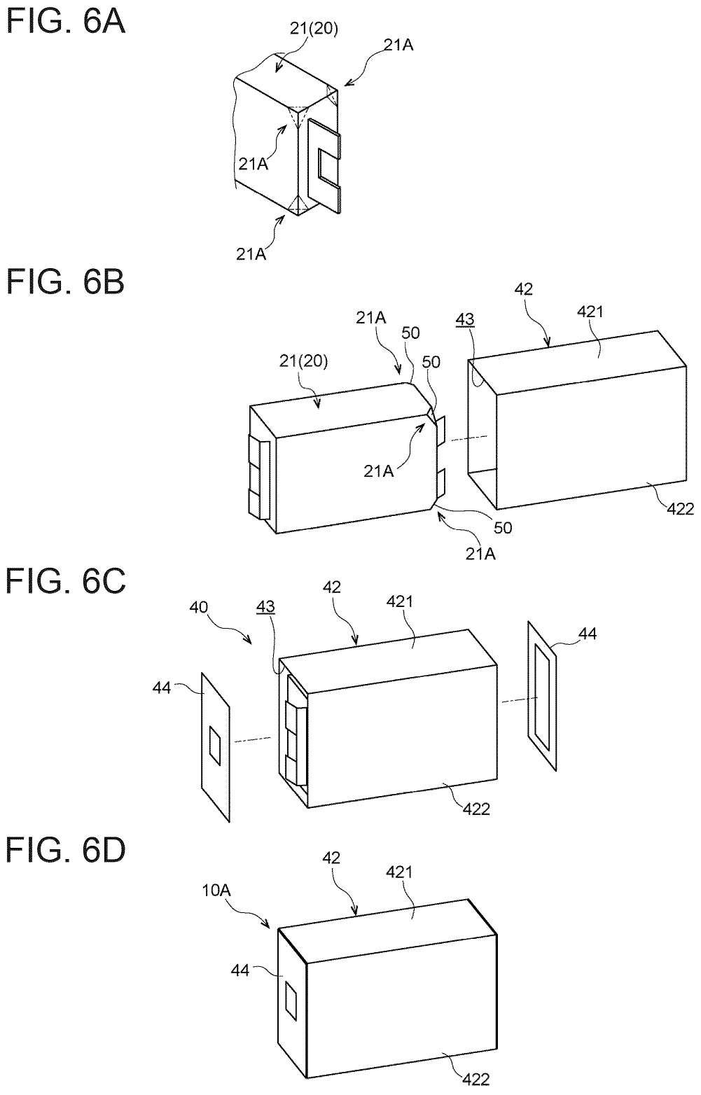

A production method for a battery according to the embodiment will be described below with reference to FIG. 6A to FIG. 6D. The production method for the battery according to the embodiment is a production method for the battery 10A, for example. The production method for the battery includes a preparation step (chamfering step), an insertion step, a resin filling step, a terminal connection step, and a sealing step.

### Preparation Step

In the preparation step, a unit electrode body 11U is formed. In the unit electrode body 11U, a positive electrode current collector sheet, a positive electrode active material layer sheet, a solid electrolyte layer sheet, a negative electrode active material layer sheet, a negative electrode current collector sheet, a negative electrode active material layer sheet, a solid electrolyte layer sheet, a positive electrode active material layer sheet, and a positive electrode current collector sheet are stacked in this order. Then, a step of connecting a positive electrode current collecting tab 12 to a positive electrode current collector 114 of the unit electrode body 11U and connecting a negative electrode current collecting tab 13 to a negative electrode current collector 115 of the unit electrode body 11U is executed.

Next, a step of obtaining the electrode stack 20 by stacking a plurality of unit electrode bodies with the current collecting tabs is executed. The unit electrode bodies are stacked such that the whole facing surfaces of the unit electrode bodies are bonded by an adhesive or the like. Therefore, the electrode stack 20 is formed in a roughly rectangular plate shape.

Next, in the preparation step, the chamfering step is executed.

As shown in FIG. 6A, the chamfering step is a step of forming the chamfered portions 50 by chamfering the corner portions 21A provided at the end portion of the electrode stack 20 in the first direction W1. The method for chamfering the corner portions 21A is not particularly limited, and may be a known method.

Next, a step of attaching the resin sheets 30 to both side surfaces of the electrode stack 20 in the second direction W2 is executed. The method for attaching the resin sheets 30 is not particularly limited, and may be a known method.

Note that, the chamfering step may be executed after the resin sheets 30 are attached to the electrode stack 20.

### Insertion Step

As shown in FIG. 6B, the insertion step is a step of inserting the electrode stack 20 from the opening portion 43 of the case body 42. In this step, the electrode stack 20 is inserted into the case body 42, from the end portion (the other end portion in the first direction) on the negative electrode side of the electrode stack 20. The chamfered portions 50 are formed at the end portion on the negative electrode side of the electrode stack 20, and therefore, the interference between the opening portion 43 of the case body 42 and the electrode stack 20 is restrained.

### Resin Filling Step

The resin filling step is a step of forming the resin filling bodies 32 by filling the gaps between the short-side sidewall portions 421 of the case body 42 and the electrode stack 20, with the resin filling bodies 32 that are in an unsolidified state. The filling method for the resin filling bodies 32 is not particularly limited, and may be a known method. The method for solidifying the resin filling bodies 32 that are in the unsolidified state is appropriately selected depending on the kind of the resin.

### Terminal Connection Step

The terminal connection step is a step of connecting the positive electrode current collecting tabs 22 and the positive electrode terminal 26 and connecting the negative electrode current collecting tabs 23 and the negative electrode terminal 28 (FIG. 6C). Specifically, the positive electrode current collecting tabs 22 are connected to the positive electrode-side internal terminal 26A, and the negative electrode current collecting tabs 23 are connected to the negative electrode-side internal terminal 28A. The connection method is not particularly limited, and may be a known method. In the embodiment, the connection is performed by welding.

In this step, each of the positive electrode-side external terminal 26B and the negative electrode-side external terminal 28B is provided together with the insulating member 34.

### Sealing Step

The sealing step is a step of attaching the terminal wall portions 44 to the opening portions 43 of the case body 42 and sealing the opening portions 43 of the case body 42 (FIG. 6D). The sealing method is not particularly limited, and may be a known method. In the embodiment, the connection is performed by welding.

### Operation and Effect

As described above, in the battery 10A according to the embodiment, the battery 10A includes the electrode stack 20 that has a rectangular plate shape and in which the positive electrode current collector 214, the positive electrode active material layer 212, the solid electrolyte layer 211, the negative electrode active material layer 213, and the negative electrode current collector 215 are stacked, and is a so-called solid-state battery. The battery case 40 in which the electrode stack 20 is housed includes the case body 42 that is a chassis, and the terminal wall portions 44 (lid bodies), and the terminal wall portions 44 seal the opening portions 43 having a rectangular shape and provided on the two facing surfaces of the case body 42. Accordingly, the electrode stack 20 having a rectangular plate shape passes through the rectangular opening portion 43 of the case body 42, and is housed in the interior of the battery case 40.

Here, the electrode stack 20 includes the chamfered portions 50 where at least some corner portions 21A of the corner portions 21A provided at the end portion (the end portion in the facing direction of the opening portions 43) of the electrode body 21 in the first direction W1 are chamfered. Therefore, when the electrode stack 20 is put into the battery case 40, it is possible to restrain the interference between the opening portion 43 of the case body 42 and the corner portions 21A of the electrode stack 20, and to improve the insertability of the electrode stack 20 into the battery case 40.

Furthermore, at the chamfered portions 50, the corner portions 21A provided at the end portion of the electrode stack 20 and corresponding to the position of the opening portion 43 of the case body 42 are chamfered, and therefore, the volume that is removed is smaller compared to a case where the whole of a side of the electrode stack is chamfered as a corner portion. Thereby, it is possible to increase the energy density of the battery 10A.

Further, in the embodiment, the chamfered surfaces 50S at the chamfered portions 50 are configured as flat surfaces having a triangular shape, and therefore, the chamfered portions 50 can be formed by cutting the corner portions 21A of the electrode body 21 along predetermined planar directions. Therefore, it is possible to easily perform the processing and reduce the production cost, compared to a configuration in which each chamfered surface is a curved surface having an R-shape, for example.

Further, in the embodiment, as the heat conductive member, the resin filling body 32 is disposed between the end portion of the electrode body 21 where the chamfered portions 50 are provided and the inner surface of the battery case 40. Therefore, it is possible to restrain an air space from being provided between the chamfered portions 50 and the inner surface of the battery case 40, and to increase the heat release performance of the battery 10A.

Further, in the embodiment, the number of the positive electrode current collectors 214 is more than the number of the negative electrode current collectors 215, in the electrode stack 20, and therefore, it is harder for the negative electrode current collector 215 to release the heat generated by energization, compared to the positive electrode current collector 214. Therefore, the chamfered portions 50 are provided at the corner portions 21A of the end portion on the negative electrode side in the electrode stack 20, and thereby, the heat release performance at the vicinity of the negative electrode current collector 215 is enhanced because the resin filling body 32 is sufficiently disposed. Thereby, it is possible to increase the heat release performance at a portion in the battery 10A where the temperature easily increases at the time of heat generation.

Further, in the embodiment, at the corner portions 21A of the end portion of the electrode body 21 on the negative electrode side, the chamfered portions 50 are provided, and the resin filling body 32 is disposed. On the other hand, the chamfered portion 50 is not provided at the corner portion 21A of the end portion on the positive electrode side. Thereby, it is possible to efficiently increase the heat release performance at the portion in the battery 10A where the temperature easily increases at the time of heat generation, and to minimize the volume that is removed by chamfering. It is possible to efficiently increase the energy density of the battery 10A.

Further, as shown in FIG. 6B, the battery 10A according to the embodiment is produced by inserting the end portion of the electrode stack 20 where the corner portions 21A are chamfered, into the opening portion 43 of the case body 42. Thereby, it is possible to restrain the interference between the opening portion 43 of the case body 42 and the corner portions 21A of the electrode stack 20, and to improve the insertability of the electrode stack 20 into the battery case 40. Further, with the method, it is possible to obtain the battery 10A having a high energy density.

What is claimed is:

1. A battery comprising:
an electrode stack that has a rectangular plate shape and in which a positive electrode current collector, a positive electrode active material, a solid electrolyte, a negative electrode active material, and a negative electrode current collector are stacked; and
a battery case in which the electrode stack is housed, wherein:
the battery case includes
a case body that is a chassis having a tubular shape and that includes opening portions having a rectangular shape, the opening portions being provided on two facing surfaces of the case body, and
lid bodies that seal the opening portions; and
the electrode stack includes a chamfered portion where at least some of a plurality of corner portions provided at an end portion of the electrode stack in a facing direction of the opening portions is chamfered.

2. The battery according to claim 1, wherein at the chamfered portion, a chamfered surface is a flat surface having a triangular shape.

3. The battery according to claim 1, wherein a heat conductive member is disposed between the end portion where the chamfered portion is provided and an inner surface of the battery case, in an interior of the battery case.

4. The battery according to claim 3, wherein:
the number of the positive electrode current collectors is more than the number of the negative electrode current collectors, in the electrode stack; and
the chamfered portion is provided at a corner portion of the end portion on a negative electrode side, in the electrode stack.

5. The battery according to claim 4, wherein the chamfered portion is not provided at the corner portion of the end portion on a positive electrode side, in the electrode stack.

6. A production method for the battery according to claim 1, the production method comprising:
chamfering the at least some of the corner portions provided at the end portion of the electrode stack in the facing direction of the opening portions; and
inserting the electrode stack into an interior of the case body, so as to insert the end portion where the at least some of the corner portions is chamfered, into one of the opening portions of the case body.
